(19) United States
(12) Patent Application Publication
(10) Pub. No.: US 2011/0112977 A1
(43) Pub. Date: May 12, 2011

(54) Computer method of collecting, managing and using job applicant data for specific employment opportunities

(75) Inventors: Leora B. Baumgarten, (US); Charles I. Smith, (US); Ramalakshmi Ramadas, (US)

(73) Assignee: New Office Temps, Ltd.

(21) Appl. No.: 11/336,574

(22) Filed: Jan. 20, 2006

Related U.S. Application Data
(60) Provisional application No. 60/721,654, filed on Sep. 29, 2005.
(60) Provisional application No. 60/645,977, filed on Jan. 21, 2005.

(51) Int. Cl. G06Q 10/00

(52) U.S. Cl. 705/321

(57) ABSTRACT

A computer method and system by which an employer or other entity, organization or individual, can collect, manage, view, search, evaluate and store data entered by job applicants for specific employment opportunities. This invention includes a computer method and system by which the employer can create a uniquely identified customized pre-employment application designed specifically for a unique and specific employment opportunity. Furthermore this invention includes a computer method by which interested individuals can access one or multiple unique pre-employment applications, submit the requested information and exit the system, without obtaining a system registration (username or password). Also, each applicant record is linked specifically to the pre-employment application along with attached resume. This invention utilizes well established Internet conventions to allow applicants to remotely access uniquely identified Web pages containing pre-employment applications. Furthermore this invention utilizes well established Internet conventions to allow employers to access, applicant information, contained in a database and uploaded to a remote computer or server location. Employer access to the system is determined and regulated by permissions associated with their username and password. Depending on the type of customer, a unique home page can be provided for accessing the applicant information.

This application claims domestic priority from U.S. Provisional Application 60/721,654 filed on Sep. 9, 2005 and U.S. Provisional Application 60/645,977 on Jan. 21, 2005.

A computer program listing appendix is submitted on the accompanying two identical duplicate compact discs, and is incorporated herein by reference. This program is written in ASP and is compatible with any computer which is capable of operation with Microsoft Windows and which is capable of accessing the Internet and operating Microsoft Explorer (version 5.0 or higher) compatible Internet Web browser, such as Microsoft Explorer or Netscape Navigator. The program should be run with the software programs available at http://www.new-hire.com. A user name and password will be provided upon request to the Website operator.

### BACKGROUND OF THE INVENTION

It is a well established practice that many employers, be they a corporation, organization or other entity seeking to identify individuals who might potentially be employed, will announce specific employment opportunities in the newspaper, and/or on job board Web sites. These newspapers and Web sites may be partially or wholly dedicated to employment announcements. These employer's may also announce employment opportunities on their own Web site as well as other media such as radio or TV. As a result of an announcement or help wanted classified ad, many potential employees will send information to the employer to indicate the candidates' interest in and qualifications for the announced opportunity. Potential employees submit this information to the employer utilizing the method or methods requested by the employer in the advertisement. It is common that employers request a resume and cover letter be sent by a number of methods, including postal service, Email service and facsimile service. In some cases the employer may also engage the services of an outside firm or recruiter to assist. It is also common that multiple individuals working for the employer may be involved in various phases of the pre-employment process. These individuals might be managers, owners, human resources personnel or outside recruiters. For the sake of simplicity, all these individuals are referred to as the employer here.

Employers commonly receive many resumes in response to each advertised announcement. Organizing, evaluating and storing the responses can represent a formidable problem, especially if the responses arrive in a variety of formats. Employers must be able to identify duplicate submissions, evaluate submissions for appropriate qualifications and manage a pre-employment process whose goal is to identify the best qualified candidate for the open position and extend that individual an offer for employment. Additionally, employers are required by law to meet certain minimum standards for storage of candidate information following advertisements of employment opportunities.

For purposes of clarity, once a prospective employee submits information to an employer, that person is referred to as an applicant or candidate.

### Description of Prior Developments

There are various known systems for recruiting employees. For example, there are many well known job boards which advertise job openings. Some of these allow the prospective employee to search for jobs and submit an application including a resume, online. Some of these systems allow the employer to select from a set of pre-screening questions that are automatically scored. Applicants whose answers do not match the pre-set criteria are automatically rejected from the applicant pool. Prior systems include the following limitations:
a. Prospective employees must pre-register and obtain a username and password prior to submitting their application. This causes a cumbersome and often confusing intervening step.
b. Delivery of applicant information to the employer is accomplished using email. This causes an increased email volume burden for the employer.
c. Employers cannot search the entire applicant pool based on the answers provided by the applicant.
d. Employers do not have the option of setting up a customized or “branded” Web portal for their prospective employees.
e. No system exists for easily directing candidates who view newspaper classified ads to an online pre-employment application.

### FIGURES AND FIGURE DESCRIPTIONS

The accompanying diagrams illustrate specific embodiments of the invention and serve to illustrate the specific novelties of the software.

FIG. 1 gives an overview of the present invention and denominates the various actions performed by prospective employees and the employer. Prospective employees access the pre-employment application by typing in the Job ID without needing prior registration.

FIG. 2 depicts the four types of users (Administrator, Deluxe Reseller, Regular Reseller and Non-Reseller) of the present invention designed to address various needs of the employment market.

FIG. 3 is an illustration of the pre-designated set of permissions assigned to specific user types in each of the four different user modules available.

FIG. 4 describes the site management console panel and the various functionalities available for the Administrator after logging in.

FIG. 5 is a flowchart illustrating the “create-application” module of the Regular Reseller where an application is created by creating the employer account and then creating the associated application.

FIG. 6 is a flowchart illustrating the “create application” module of the Deluxe Reseller where an application is created by creating the account with a limited duration and then creating the pre-employment application.

FIG. 7 describes the “Edit Application” module of the software where the employer, with appropriate permissions, can edit the Job Title, Job Description, Customizable Questions, Application Availability and Move Job between accounts.

FIG. 8 depicts the “Customize” functionality available to the employers purchasing the system from a Reseller Regular.

FIG. 9 is a flowchart describing the “View Applicants” process of the current invention.

FIG. 10 describes the “Manage Users and Accounts” section of the software.

FIG. 11 depicts the “Edit/Upload Resume” section where the employer can upload an acceptable resume format or attach a new resume to a specific applicant record, as needed.

FIG. 12 is a flow chart of the “Move Job” section where a pre-employment job description can be moved between domains and accounts

FIG. 13 is a flow chart illustrating the “Questionnaire templates” where the employer can create/edit/delete a pre-built template library

FIG. 14 is a flow chart describing the “Billing module” where the administrator can generate invoices of unbilled pre-employment application in a particular domain and account.

### SUMMARY OF THE PRESENT INVENTION

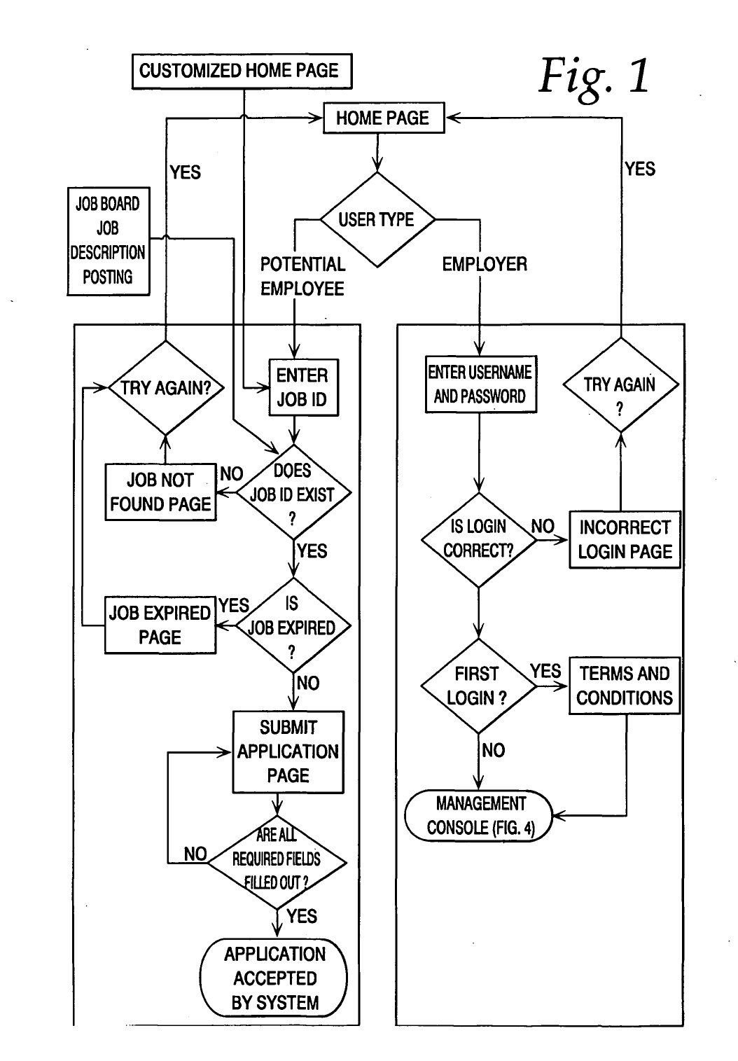

As suggested in FIG. 1, the invention described here provides employers with a computer method for harnessing Internet conventions and protocols to collect, manage, store and evaluate the information submitted by applicants in response to a unique advertised employment opportunity. This method represents an improved and streamlined interaction between the applicant and the potential employer. It also provides a method for improving the efficiency for employers in organizing and controlling the pre-employment data management systems and processes. This invention represents an innovative and improved pre-employment candidate management system designed to help employers save time and money during the hiring process.

Specifically, the customized pre-employment applications allow the job seeker to provide specific information requested by the employer. This unique customized application makes it possible to collect the same information from prospective employees regardless of the media (Newspaper, Web based job board, TV or radio) used to publicize the employment opportunity. All the applicant information for a specific job is stored in a centralized repository database on a remote server. This information can be accessed from any PC anywhere with the capability of accessing the Internet. Additionally, the applicant data pool is searchable based on the answers of the job seeker. The search process is described below.

Consider a scenario where the prospective employer has requested specific information from the applicant relating to his or her length of experience with Lotus Notes software. The applicant can select one of the answers provided, using a radio button selection. Here are 4 sample answers:
a) 0-2 years
b) 3-4 years
c) 5-6 years
d) 7 or more years

The employer only wants to see people with seven or more years experience using Lotus Notes, because it is a key job skill for this opportunity. The employer can search the total applicant pool of 100 for those who marked option d) “7 or more years”. Of the 100 applicants only 10 people have indicated this experience level and are returned by the search. This search result simplifies the process of identifying qualified applicants and saves the employer time, otherwise wasted reviewing unqualified applicants. Any other skills based questions can be substituted for this example.

Similarly, employers can request and search for information about multiple job skills. For example the employer can identify individuals who indicate experience with multiple specific software applications. Employers can also request applicants to provide essay style answers to scenario based questions, specific to the employment opportunity. Thus the employer can screen for applicants with appropriate communication skills and understanding of work process. Applicants whose written communications skills or process knowledge are insufficient for the advertised job opportunity can be designated as “Not Qualified” and their record can be marked as such.

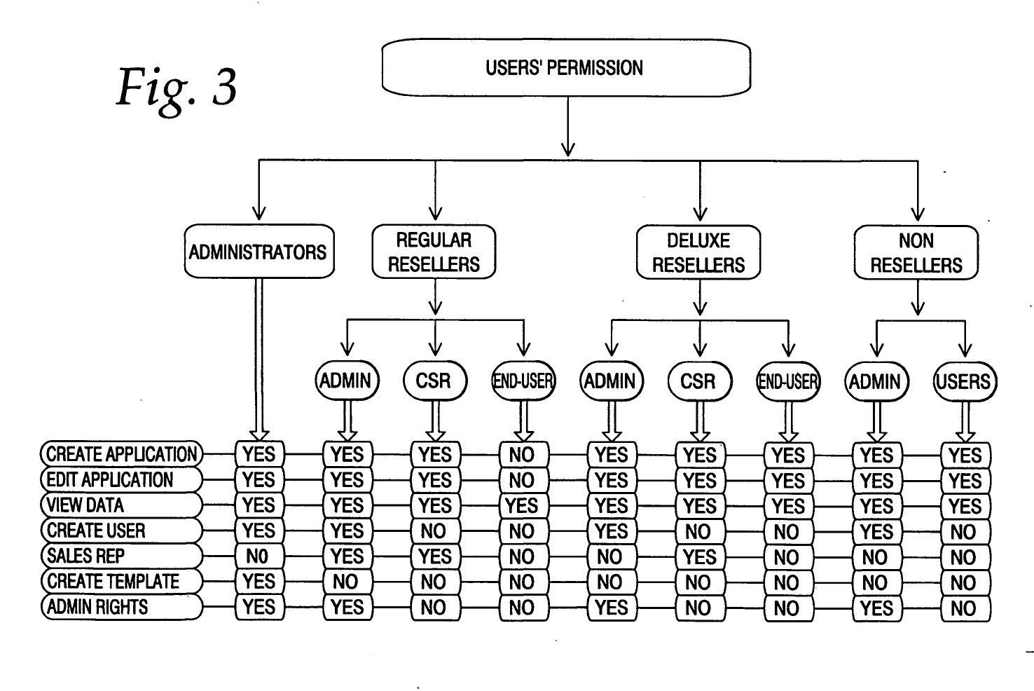

The present invention has four modules customized for different employment needs. These modules are shown graphically in FIG. 3.

Software System Administrator. (FIG. 3) This configuration is only available for designated internal employees who are providing system administration or customer service. It allows access to:
i All site licensees (domains) and accounts (customers of site licensees), including all customer information
ii All usernames and passwords
iii All pre-employment questionnaires and associated applicant information
iv A billing module to generate invoices
v A variety of other management functions designed to allow creation of site licensed domains and (subsidiary customer) accounts and usernames and passwords.
vi A variety of management functions designed to provide customer service including but not limited to: attaching new resumes to applicant information, moving pre-employment application between accounts/domains, and creating questionnaire templates, deleting jobs and a sales report of all the reselling of the software
vii Create, View and Edit pre-employment applications for all domains and accounts.
viii Extend the expiration date for a pre-employment application for all domains and accounts

Non-Reseller or Human Resources configuration. This configuration is designed for the Human Resources department of an employer. For this type of site license, all access is open-ended; both accounts and pre-employment application have no pre-set expiration time. This configuration allows the employer to:
i Manage users and accounts in their domain
   Set up departmental accounts and user groups
   Set up new users and give them access to specific departmental accounts and pre-employment applications
   Change the logo displayed on the pre-employment applications generated in their domain.
ii Create, View and Edit pre-employment applications for all accounts in their domain

Reseller Deluxe configuration. This configuration is designed for full service recruiters working in staffing or classified advertising agencies. These companies work on behalf of an employer (who is their customer and the system's end user) to identify qualified applicants. This configuration allows site licenses designated as resellers of the system to manage their customer accounts. These customer accounts are set up with a fixed duration for customer access, after which time customer accounts expire. The system sends automated emails notifying customers of account expiration. This configuration allows the site licensee to:
i Manage and set up customer accounts
   Customer accounts retain access to Create, Edit and View only.
ii Set up and manage user names and passwords for customer accounts
iii Create, Edit, View pre-employment applications and applicant data for all customer accounts.

Reseller Regular Configuration. This configuration is designed for certain types of resellers to create time bounded pre-employment applications for their customers use and include certain additional uniquely identifying information that is linked to each individual pre-employment application. Accounts are set up by the reseller staff. Each account is linked to a user name (and password) and a pre-employment questionnaire. These pre-employment questionnaires have a fixed duration (e.g. 30 days) which is set by the Software Systems Administrator and determined by the terms of the site license. The system sends the employer (customer) automated emails containing username and password, application URL and Job ID number information. Prior to the application termination, alert emails are also sent automatically. This configuration allows resellers to:
i Quickly make new accounts, or access existing accounts. Each account is associated with an employer and a minimum of one pre-employment questionnaire.
ii Create one of two types of pre-employment applications: Basic or Enhanced. The Basic questionnaire includes applicant contact information, past work history, references and applicant's resume. The Enhanced pre-employment application allows the employer to add customized, job specific questions to the pre-employment application.
   Employer accounts have limited access to software functionality. These employers are credentialed for View, and Customize, if they have purchased an Enhanced application. Employers who purchase a Basic application only have access to View. All employers also have access to Help and Edit profile.
   In this configuration the create module is modified to allow employers to customize only applications identified as Enhanced.
iii Get access to unique Job ID and URL for every pre-employment application created for their customers. This information is placed in classified ad text, to direct prospective employees to apply online.
iv Mange their customer accounts as needed.
v Extend the duration of pre-employment application if the customer requests for extension.
Generate a sales report of all the sales within the domain.

### DETAILED DESCRIPTION OF THE PREFERRED EMBODIMENTS

### General Description

As shown in FIG. 1, this novel computer method and system facilitates the data management and prescreening functions unique to the recruiting and hiring process and represents a new invention and development of Candidate Management Software. The home page is a dynamic Web portal for both prospective employees and for the employer. Prospective employees can apply for employment (without registering) using a unique Job ID number, and employers can logon and review applicant information. The main functionality allows credentialed users who are employers, to create customized online pre-employment application questionnaires. Each questionnaire is given a URL and Job ID which serves as its unique identifiers. All data associated with each pre-employment application is stored in a standard format in a database and can be retrieved and sorted. All data is accessed via the Internet and has 128 bit encryption.

### Functionality

There are two primary types of users for this system:
1. Applicants
2. Employers (who receive an username and password.)

Prospective employees access the invention using one of the variety of Web browsers as is customary for accessing the Internet. Prospective employees access the Web-native pre-employment application created by the invention and designed to collect the information that an employer needs to make informed hiring decisions. Prospective employees access the application via a designated Web portal (such as www.new-hire.com) where they enter the unique Job ID number advertised in a print classified ad or Web posting. Prospective employees may also access a specific pre-employment application directly from a link posted on a Website. To apply for a specific job, prospective employees must complete the required fields (contact information) and answer the questions in the application. This includes, for example, entering first and last name, mailing address, phone number, email address, and level of education, as well as entering answers to job specific questions. Prospective employees have the opportunity to attach a formatted electronic resume, which is linked to the other information captured.

Once each prospective employee has completed the online pre-employment application, and attached an electronic resume the prospective employee clicks the “submit” button at the bottom of the application. By clicking the “submit” button the information is added to the database. Once the prospective employee has completed the pre-employment application and submitted the information to the database, the prospective employee becomes an applicant for the specific employment opportunity. Applicants do not have access to any other section of the software invention.

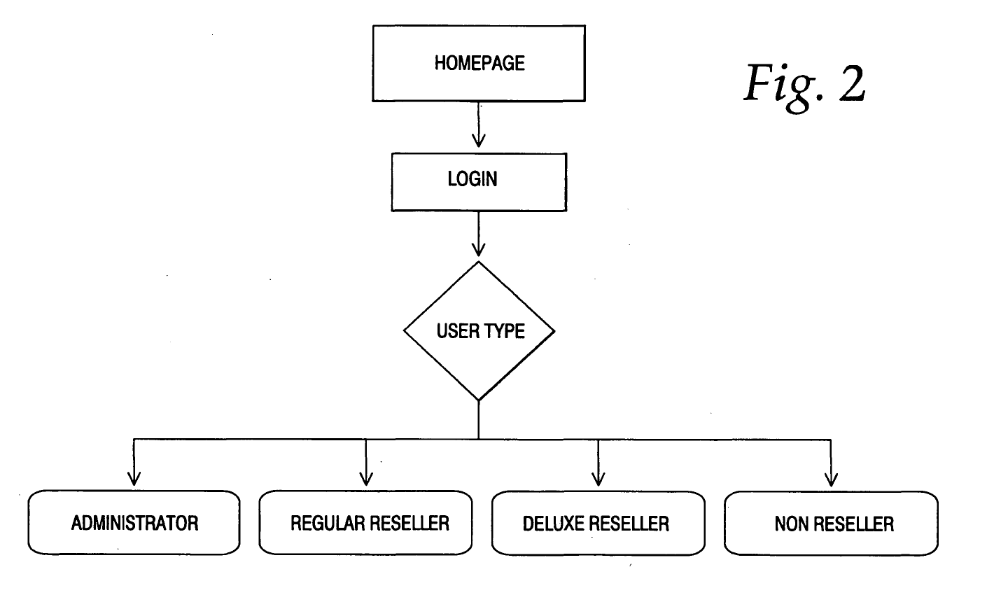

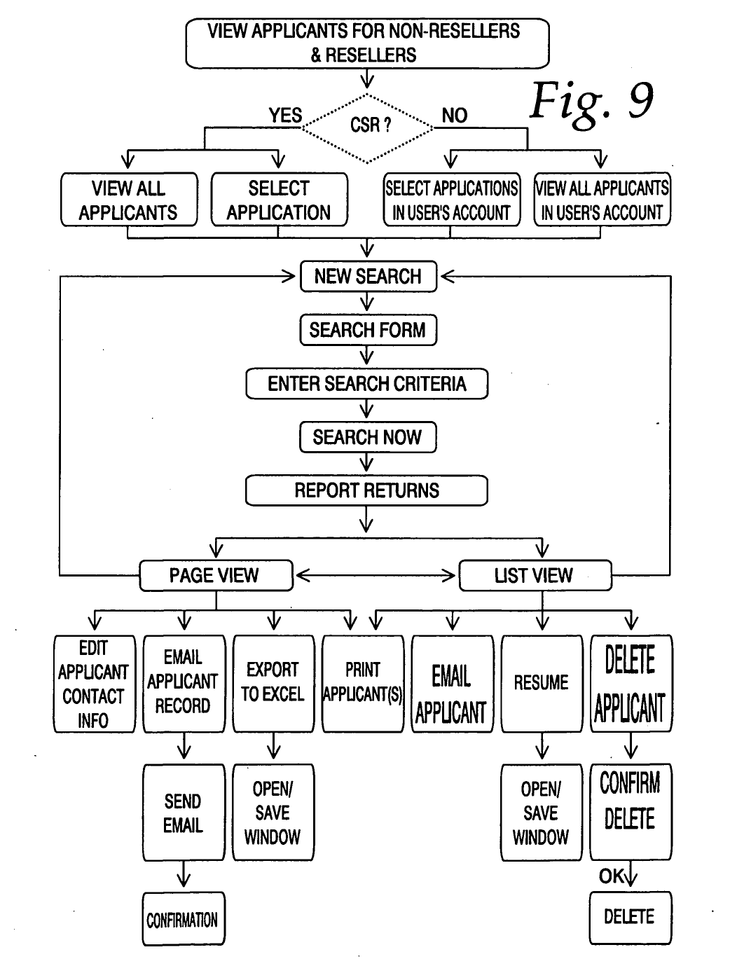

Employers who wish to access the system must first become customers and receive a username and password. As suggested by FIGS. 2 and 3, an employer accesses the invention using one of a variety of Web browsers as is customary. Employers access to the invention is governed by username and password. Permissions set within the invention affect the type and extent of customer access to the invention. In general, employers use the invention described here to create customized online pre-employment applications and to gather, store and sort applicant data. The stored applicant data forms a database that is searchable on multiple parameters. For example, employers can select specific skills or experience criteria that are listed in the Web-native pre-employment questionnaire. The employer can actively search the applicant data pool for applicants whose records match those desired criteria. (FIG. 9)

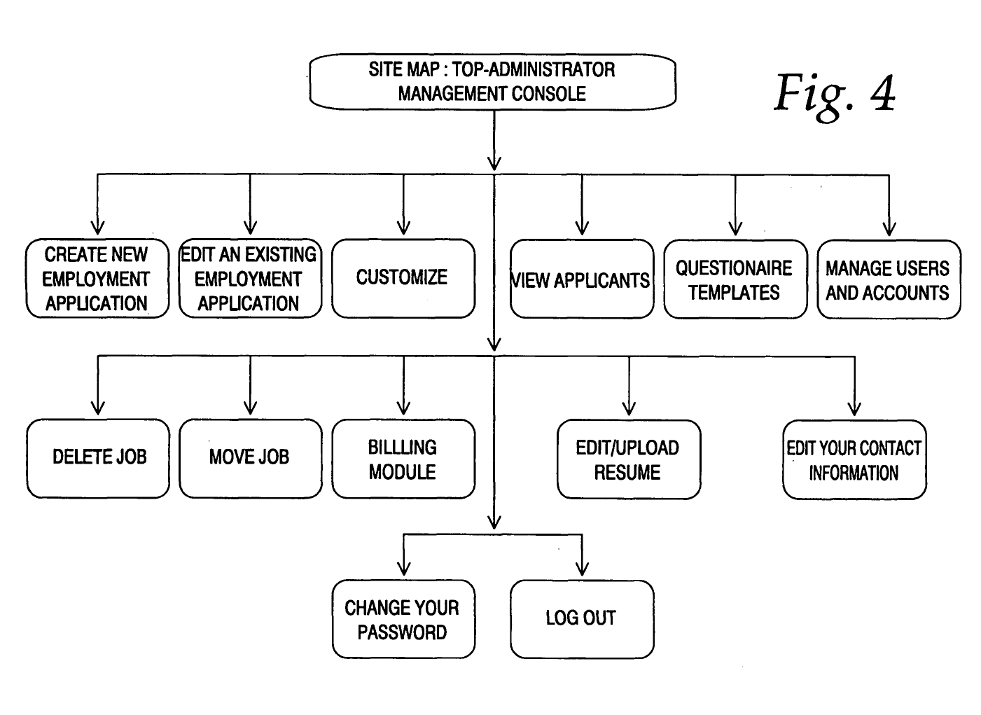

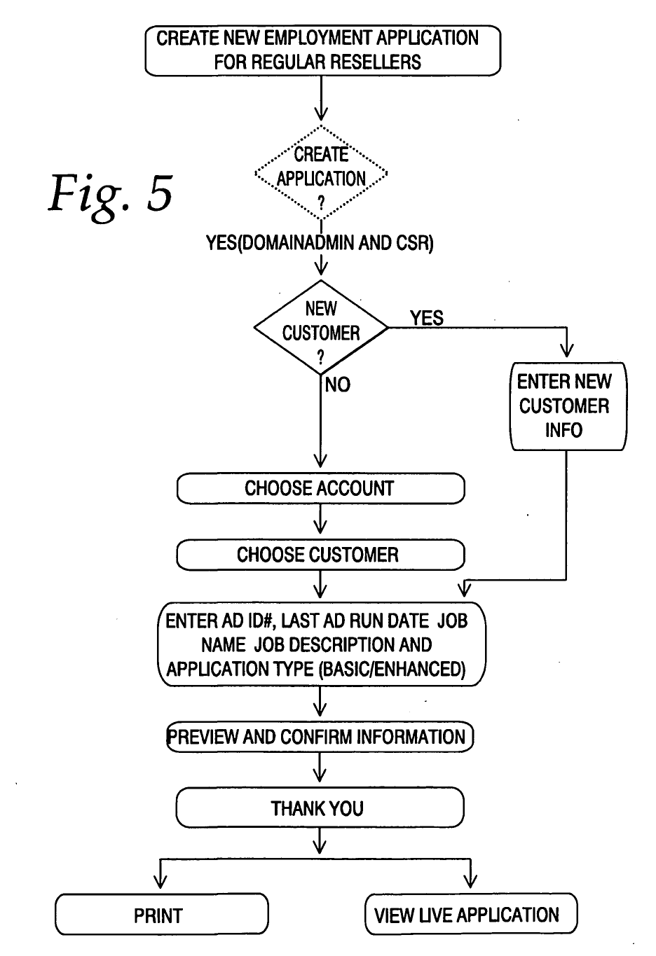

Employers have access to three primary components of the software. Each component allows the employers to do specific actions or tasks. Access to each component is set by permissions associated with the username and password and determined by the license agreement accepted by the employer at the time of purchase. The three primary components of the invention are:
1. Manage console (FIG. 4)
2. Create (or customize) a pre-employment application (FIGS. 5, 6 and 8)
3. View (sort, search, annotate, and store) applicant data (FIG. 9)
   The description of the specific actions and functions of each component follow.

Manage Console (FIG. 4)

When an employer logs on to the system, using the accepted and customary steps known to users of the Internet, the employer enters the invention at the Manage console. This console includes a menu from which the employer can access all of the other functions. Employers navigate the software and select actions by clicking on the appropriate link as is customary and familiar to people who utilize the Internet. Most employers have access to a limited choice of actions:
1. Help
2. Create a new Employment Application
3. Edit an existing employment application
4. Customize (customers of regular resellers only)
5. View Applicants
6. Manage Users and accounts (Administrators of reseller domains and top level administrators only)
7. Edit your contact information
8. Change your password

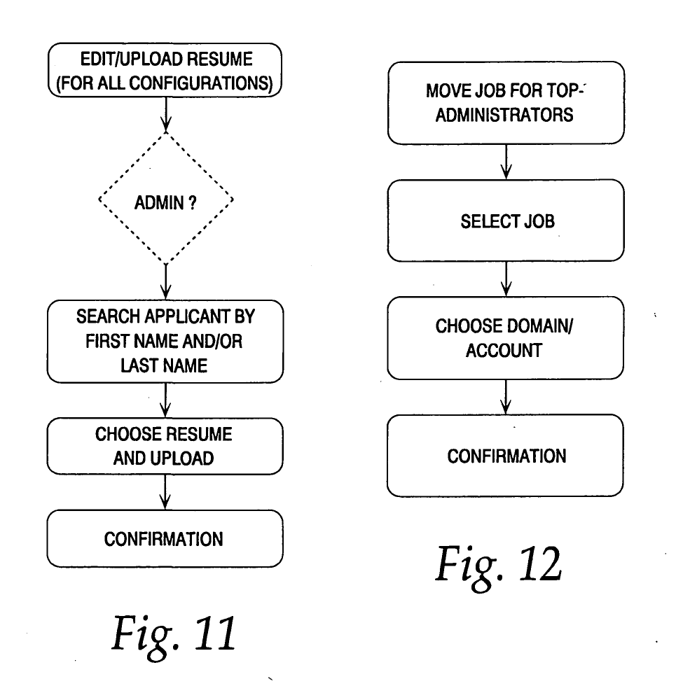

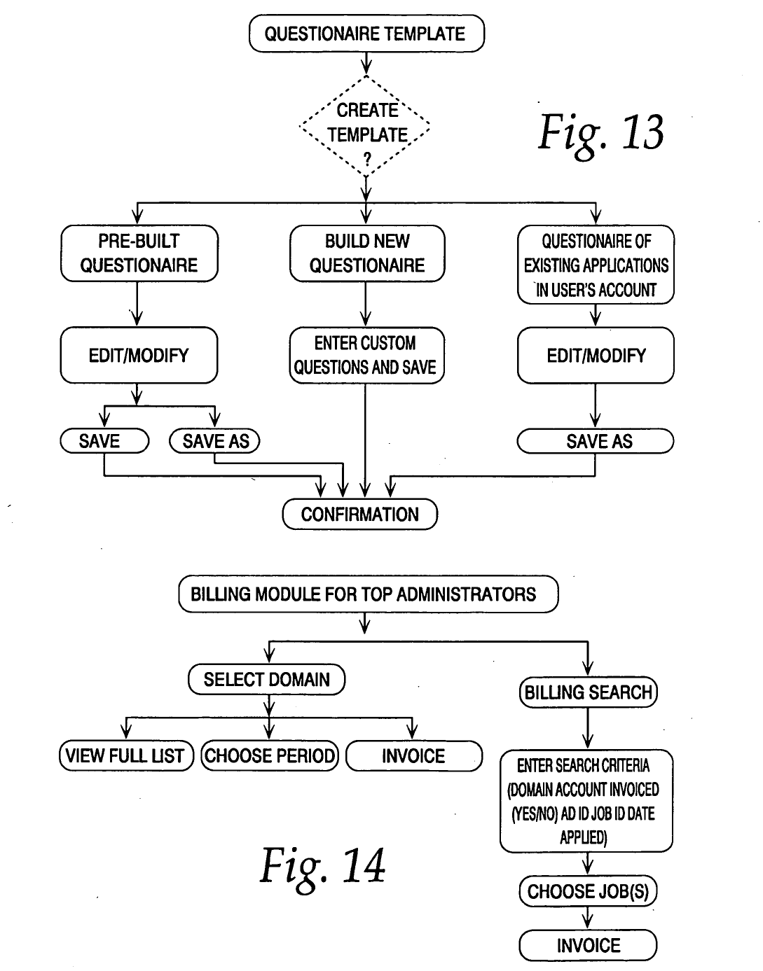

Administrative permissions (FIG. 3) allow the display of additional actions used to administer the account or to provide customer services. These links allow access to administration and customer service functions such as creating invoices for billing purposes, (FIG. 14) attaching new resumes to applicant records (FIG. 11), updating the library of questionnaire templates (FIG. 13), deleting duplicate applicant information, managing user access to the system and other internal functions as necessary.

Described here are the most common functions that employers can access from the manage console.

Help

Selecting Help displays the user's guide to the software invention described here.

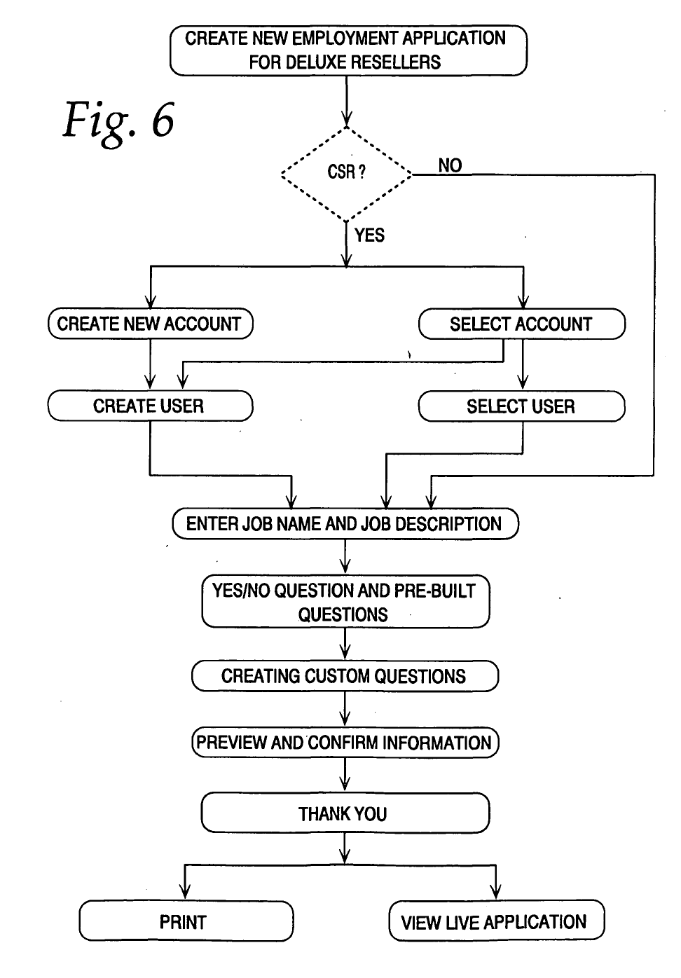

Create (FIGS. 5 and 6)

To create a new pre-employment application an employer selects the “Create” button or the “create new application” text link found on the Manage console. This action allows the employer to build a customized pre-employment application. Employers follow a step-by-step method to create the pre-employment application. Once created, each pre-employment application has a unique URL and a unique Job ID number automatically assigned by the system. This information must be included in any recruitment advertising, directing prospective employees to access the online pre-employment application. Employers follow the step-by-step method as it is displayed on their computer monitor.

The following information is automatically collected in all questionnaires and no special action is required by the employer to include the following information in the pre-employment application: Title, First Name, Last Name, Address 1, Address 2, City, State, Zip, Email address, Home phone, Cell phone, Work phone, Best contact time, Best phone number, Highest level of education completed, Institution, and Available date to start work.

Step One—Setting the Account for the application, the Job Name and the Job

### Description. (FIGS. 5,6)

a. Employers with certain permissions can select the Account for which this pre-employment application is being created. This action is accomplished by clicking the down arrow to display a list of available accounts, and select the appropriate account. Employers can add a new Account if necessary by going to “Manage” and selecting “Add Account”.
b. Employers then enter the Job Name by typing it in the designated location.
c. Employers enter the Job Description by typing it in the designated location. Enough detail should be included so a prospective employee will know if they are interested and qualified to apply for the position.
   When this session is complete, the employer will click the “next” at the bottom of the page to go to Step Two.
   Step Two—References, Job History and Referring classified ad. (FIGS. 5-6)

a. Employers specify whether or not to include a request for personal references and job history in the pre-employment application, by selecting the radio buttons with a Yes or No response. Choose “yes” to ask job applicants to provide the names and telephone numbers of two references. Choose “no” to exclude this option from the questionnaire.

b. Employers specify whether or not to include Job History in the pre-employment application. Choose “yes” to ask job applicants to enter Employer and Dates Employed and Job title for the three most recent jobs. Choose “no” to exclude this option from the questionnaire.

c. Employers specify whether or not to include questions asking applicants where he/she heard about or saw the posting for the job. Choose “yes” to ask job applicants where they heard about the job. Choose “no” to exclude this option from the questionnaire.

### Step Three—Building the Application Questionnaire. (FIG. 6)

a. Employers can opt to populate the questionnaire with questions from a questionnaire template library. By selecting from the pick list in the drop-down menu, a set of pre-built questions will populate the customized section of the pre-employment application. These questions can be used as is, or as a starting point to be edited as needed.

b. Alternatively, employers can opt to enter their own unique questions by typing them into the location provided. Up to twelve questions can be used to help identify the best-qualified candidates for the open job. For each question entered, an answer type must be selected. (For more details about the answer types, see below).

Questions require answers in one of the following four formats:
Radio Button—only one answer out of a set can be selected by the applicant.
   (Example Question: Are you available to work from midnight to 8 a.m.?Example Answers: Yes or No
Check Boxes—one, a combination, or all of the set can be selected by the applicant.
   (Example Question: What software do you have experience using? Example Answers: MS Word, MS Excel, MS Access and/or Lotus Notes)
Text Field—allows applicant to enter any text up to 250 characters (approximately 45 words) in length.
   (Example: List the types of financial licenses that you hold).
Memo Field—allows applicant to enter an extended answer in paragraph form.

When the custom questions are complete, the employer clicks the “Preview Application” button at the bottom of the page. This Preview is exactly what will appear on the live pre-employment Web application. To make changes, the employer clicks “Back”. To complete the process, the employer selects “Post” to instantly post the application to the Internet.

The system automatically generates, displays and emails the Job ID and URL Website information for each unique pre-employment application to the employer. Employers include this information instead of including a fax number or email address for prospective employees to respond to the recruitment ad.

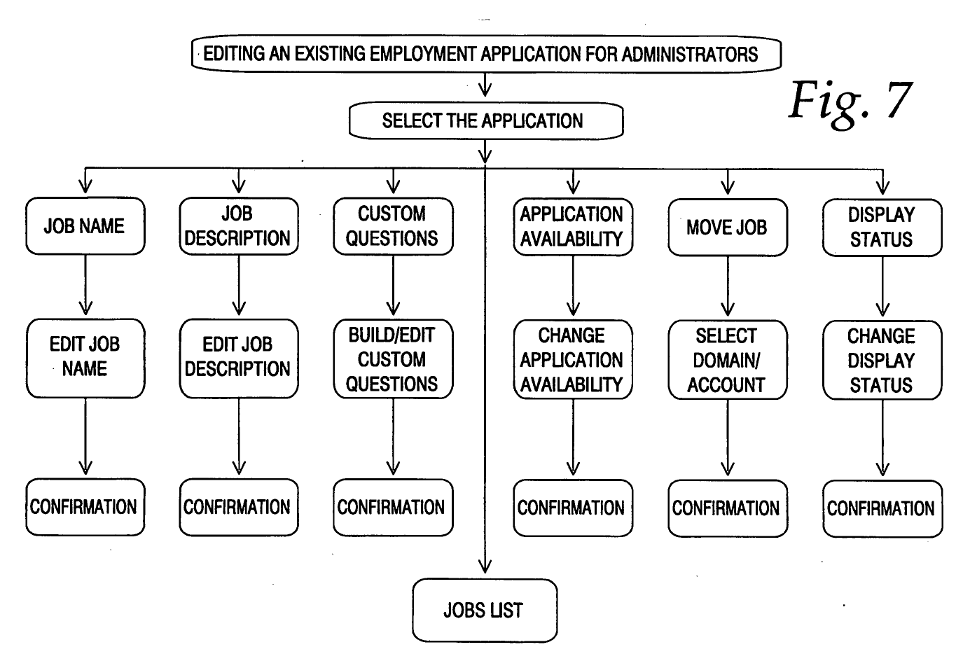

Edit (FIG. 7)

To edit an existing pre-employment application, the employer selects and clicks on the “edit an existing application” link from the Manage console. A table listing all the applications available to that employer appears. The employer selects and clicks on the single application to be edited. An employer, depending on the permissions associated with the username and password, can edit the Job Name, Job Description, or Custom Questions (for administrators only). From this menu, the employer can perform some other actions as well. An employer can:
a. Choose to display the job posting on a specific corporate Web site job board
b. change the application availability—whether or not the application accepts new applicant data
c. move the pre-employment application from one account to another within that domain (FIG. 12)

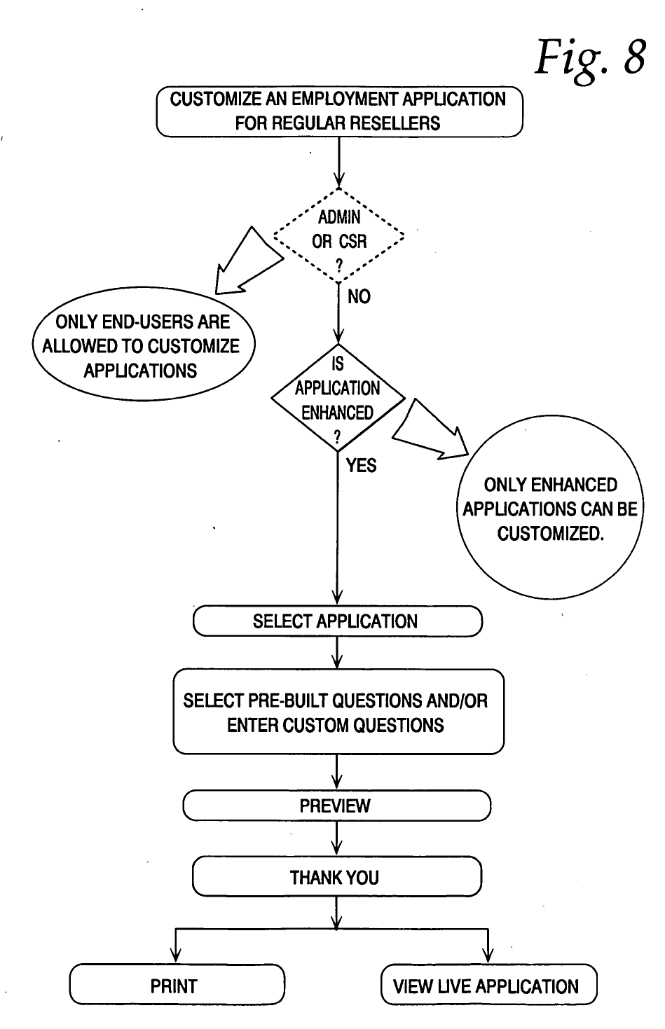

Customize (FIG. 8)

“Customize” is a specialized function for employers who are customers of Regular Resellers of the system. This feature allows employers to add customized questions to pre-employment applications, which is generated for them by their vendor, the Regular Reseller. By selecting the “customize” link from the Manage console, the employer can follow two steps to add custom questions to a pre-existing unique pre-employment application. The steps are used identical to those described in Step 3 of “create”.

View (FIG. 9)

To view, sort, screen and mark applicant records, the employer selects the “View applicant” button or text link from the Manage console. A table of all the pre-employment applications available to that employer appears. The employer can select the job whose applicants he or she wishes to review by clicking on either the job name or the job number.

The employer then sees the search screen. There are several possible actions from this page. The employer can view information submitted by each applicant, one at a time, by paging though the records. The employer can choose to see a list of all the applicants. Or the employer can choose to search the database, based on a variety of search criteria. The actions available to the employer are indicated by buttons or clearly labeled links.

Individual applicant records can be reviewed and marked using the applicant tracking features. Individual applicants can be emailed directly from their record, by simply selecting the appropriate link. Applicant records can be emailed to a stakeholder outside the system and the record can be printed. The applicant's resume is available for review by selecting the “resume” link associated with each applicant record. Resumes are also available for review in the “list view”.

Employers can utilize the applicant tracking features to indicate the applicant's level of qualification (i.e. “incomplete application”, “qualified”, “maybe”, “not qualified”, etc.) for the position by selecting the appropriate field and then clicking the “Update” button. The employer can input unlimited notes in the “notes” filed and can also mark the level and frequency of contact by selecting the appropriate check boxes (i.e. “emailed”, “left message”, “phone interview”, etc.) and then selecting the “Update” button. All information added here becomes a permanent part of the applicant record and can subsequently be searched using the appropriate criteria in the search screen.

The invention also allows employers to use Microsoft® Excel to download and save a variety of candidate information. This function can be accessed from the “Page View” or “List View” pages.

Employers can search for specific information or applicant criteria of interest by filling out the search from and then clicking the “Search Now” button. For example, to find John Smith's application, his name is entered into the name field. Similarly, check boxes or radio buttons with the desired information from specific questions can be selected in the search page. For example, if a college degree is a job requirement, the employer can select the “College Graduate” check box, and the click “search now.” The system returns only those applicants with a college degree. For a narrow search multiple criteria can be selected. Only applicants that meet the selected search criteria are returned.

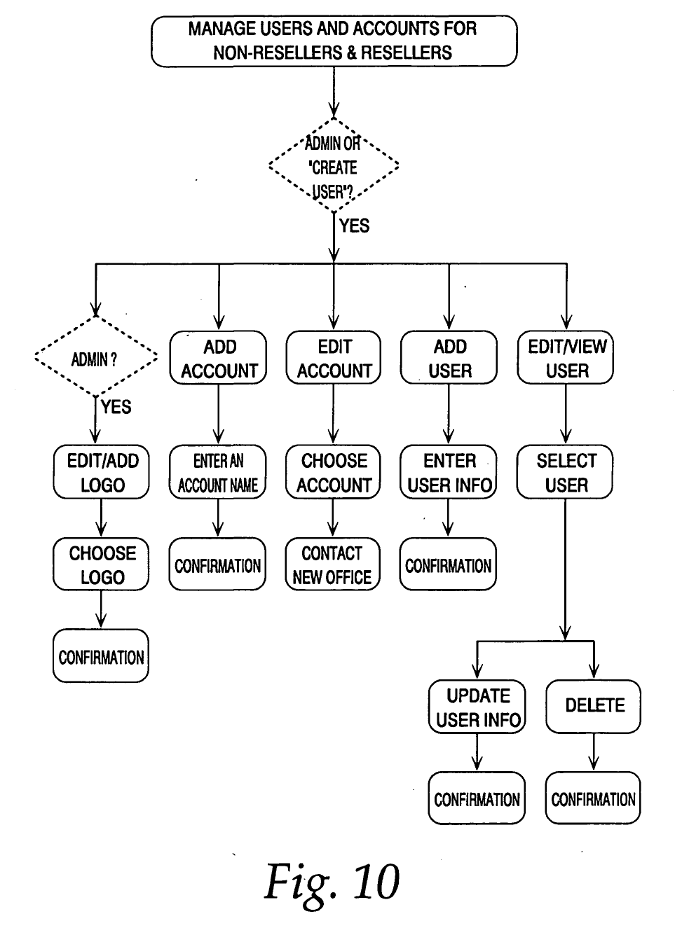

Manage Users and Accounts (FIG. 10)

To manage users and accounts, the appropriately credentialed employer or other administrative user selects the “Manage Users and Accounts” link from the Manage console. Depending on the employers' permissions and related account access, a variety of functionality is available from this section of the software.

Employers may be able to access some or all of the functions listed below, by selecting the appropriate link:
a. Add a domain—allows top level administrators to create a new domain location for site licensed employers to access the system.
b. Add/Edit logo—allows a domain level administrator to add or change the logo that is displayed on their pre-employment applications.
c. Add/edit Account—Allows a unique account or user group to be created within a domain
d. Add User—allows the addition of a new username and password to a specific domain or account, and allows setting of the permission for that employer to access the system.
e. Edit/View user—allows the employer's username, password, contact information and permissions to be viewed, changed and updated. Employers can also be deleted from the system.

Edit Contact Information

From the Manage console all employers have access to selecting the “edit contact information” link. Once selected, a form appears that is populated with the employer's contact information, including the first and last name, address, phone number, email address, etc. Changes can be made to any of these fields and the information is saved, when the “update” button is clicked.

Change Password

From the Manage console, employers can select the “change password” link. Once selected, a form appears that allows the input of the old password and the new password. Clicking the “change” button stores the new password.

Summary

The functions detailed here and further described in the claims sections, together, represent a novel invention for creating online pre-employment applications which are fully customizable for specific employment opportunities. The system creates a unique URL and Job ID number for each pre-employment application. Applicants access and enter the requested information into the system without registering or obtaining a username or password. Employers, who are customers of the system, access the invention via the Internet using a unique username and password. The level of the employer's access to the system is determined by permissions attached to the username and password. Once in the system, the employer creates Web-native pre-employment application and views, searches, sorts, screens and marks applicant records for the purpose of selecting the best qualified applicant for employment:

1. A computer system for permitting an employer to assemble and analyze data relating to prospective employees, the system comprising
means for creating a uniquely identified Web page assigned to a unique Universal Resource Locator and a unique Job Identification number, containing specific, but customizable, content of a pre-employment application
means for presenting job identification and description data to prospective employees
means for presenting customized job specific questions in the form of a questionnaire relating to the prospective employee's work history, experience, knowledge or skills at a site available on said uniquely identified Web page,
means for recording, in a relational database, an information set of responses to said job specific questions, said set of responses being presented in a pre-determined format,
means for optionally receiving and recording an information résumé saved in a predetermined electronic format and for relating that résumé to said set of responses, and
means for optionally receiving and recording additional information such as work history, personal references, and the identity of a referring source, and for relating that additional information to said set of responses.

2. A computer system according to claim 1 further including means permitting said employer to access said information supplied by said applicant for a limited period of time.

3. A computer system according to claim 1 further including means for permitting said prospective employees to directly access the unique Universal Resource Locator without prior registration.

4. A computer system according to claim 1 further including means for searching submitted questionnaires for pre-selected answers, and means for identifying and presenting questionnaires having said pre-selected answers.

5. A computer system according to claim 1 further including means for creating a unique Universal Resource Locator and a unique Job Identification Number to be presented to prospective employees for use by said prospective employees in accessing said computer system.

6. A computer system according to claim 1 further including restrictive access means for permitting only predetermined employers to access information presented by prospective employees,
and sort and search means for permitting only predetermined system users to sort and search said information received from prospective employees, said sort and search means including
Means for appending said information with notes;
Means for appending said information with a qualification status; and
Means for appending said information with tracking information

7. A computer system according to claim 6 further including multiple prospective access means for providing various different system users with various different forms of system access and
Means for limiting that access to a pre-determined length of time

8. A computer system according to claim 1 further including means for automatically emailing information to the employer regarding the employer's username and password and
Means to email the employer the URL and Job ID of a specific pre-employment application

9. A computer system according to claim 4 further including means for emailing information about selected prospective employees to predetermined email addresses

10. A computer system according to claim 1 wherein multiple current employees of said employer have access to information provided by said applicants, the system further including means for defining the nature of the access to be had by each current employee, said nature being established prior to initial system access by said current employee.

11. A computer system according to claim 1 further including means for identifying a particular set of said job specific customized questions, means for identifying responses to at least some of the questions in said particular set of job specific customized questions, and means for developing a report based on set questions and said responses.

12. A computer system according to claim 1 further including means for generating invoicing statements to be sent to said employer.

13. A computer system according to claim 12 wherein said means for generating invoicing statements includes means for generating said statements based upon pre-determined system use parameters.

14. A method of using a computer to permit an employer to assemble and analyze data relating to prospective employees, the method comprising the steps of
presenting job identification and job description data to prospective employees
creating a uniquely identified Web page having assigned to it a unique Universal Resource Locator and a unique Job Identification number
presenting said Web page to prospective employees,
presenting customized job specific questions relating to the prospective employee's work history, experience, knowledge or skills,
recording and storing, in a relational database, responses to said job specific questions, said responses being presented in a pre-determined format,
recording and storing, in a relational database, standardized information relating to each prospective employee,
optionally receiving and recording a résumé saved in a predetermined electronic document format and relating said résumé to said responses to job specific questions from said prospective employee, and
optionally receiving and recording additional information such as work history, personal references, and the identity of a referring source and relating in said additional information in to said responses to job specific questions from said prospective employee.

15. A method according to claim 14 further including the steps of searching said response to said job specific questions;
identifying prospective employees who have submitted responses of a pre-determined nature,
and presenting identifying information about said identified prospective employees to said employer.

16. A method according to claim 15 further including the steps of emailing information, to at least one email address associated with said prospective employer, about at least one identified prospective employee.

17. A method according to claim 14 further including the step of generating at least one invoicing statement for use of said method,
and forwarding said invoicing statements to said prospective employer.

18. A method according to claim 14 further including the step of restricting access by at least some method users to at least some of the information generated by said method according to user identification information assigned to said users.
